(19) United States
(12) Patent Application Publication
(10) Pub. No.: US 2015/0092131 A1
(43) Pub. Date: Apr. 2, 2015

(54) LIQUID CRYSTAL DISPLAY AND METHOD OF MANUFACTURING THE SAME

(71) Applicant: Samsung Display Co., Ltd., Yongin-city (KR)

(72) Inventors: A Ram Lee, Yongin-city (KR); Seung-Yeon Chae, Yongin-city (KR); Sang Gun Choi, Yongin-city (KR); Ha-Young Park, Yongin-city (KR); Tae-Woon Cha, Yongin-city (KR); Se Hee Han, Yongin-city (KR)

(73) Assignee: Samsung Display Co., Ltd., Yongin-city (KR)

(21) Appl. No.: 14/249,654

(22) Filed: Apr. 10, 2014

(30) Foreign Application Priority Data
Oct. 1, 2013 (KR) 10-2013-0117367

(51) Int. Cl. G02F 1/1337; G02F 1/1343; G02F 1/1362

(52) U.S. Cl. CPC G02F 1/1337; G02F 1/136209; G02F 1/134309
USPC 349/43; 438/30

(57) ABSTRACT

A liquid crystal display includes a substrate, a thin film transistor disposed on the substrate, a pixel electrode disposed on the thin film transistor, a roof layer facing the pixel electrode, and at least one partition wall disposed along an edge of the substrate, in which a plurality of microcavities is formed between the pixel electrode and the roof layer, and the plurality of microcavities includes a liquid crystal material.

### CROSS-REFERENCE TO RELATED APPLICATIONS

This application claims priority to, and the benefit of, Korean Patent Application No. 10-2013-0117367 filed in the Korean Intellectual Property Office on Oct. 1, 2013, the entire contents of which are incorporated herein by reference.

### BACKGROUND

1. Field

The present disclosure relates to a liquid crystal display and a method of manufacturing the same.

2. Description of the Related Technology

A liquid crystal display which is one of the types of flat panel displays currently in use, includes two sheets of display panels with field generating electrodes such as a pixel electrode and a common electrode, and a liquid crystal layer interposed therebetween.

The liquid crystal display generates an electric field in the liquid crystal layer by applying voltage to the field generating electrodes, determines the direction of liquid crystal molecules of the liquid crystal layer by the generated electric field, and controls polarization of incident light, thereby displaying images.

A technique of implementing a display by forming a cavity as a pixel unit and filling a liquid crystal therein has been developed. The technique is a technique for manufacturing a display by forming a sacrificial layer with an organic material and the like instead of forming an upper plate on a lower plate, removing the sacrificial layer after forming a support member thereon, and filling a liquid crystal in an empty space formed by removing the sacrificial layer through a liquid crystal injection hole.

The above information disclosed in this Background section is only for enhancement of understanding of the background of the invention and therefore it may contain information that does not form the prior art that is already known in this country to a person of ordinary skill in the art.

### SUMMARY OF CERTAIN INVENTIVE ASPECTS

The present disclosure has been made in an effort to provide a liquid crystal display and a method of manufacturing the same having advantages of preventing an over-supplied aligning agent from affecting a pad portion even though the aligning agent is over-supplied.

One embodiment provides a liquid crystal display, including: a substrate, a thin film transistor disposed on the substrate, a pixel electrode disposed on the thin film transistor, a roof layer facing the pixel electrode, and at least one partition wall disposed along an edge of the substrate, in which a plurality of microcavities is formed between the pixel electrode and the roof layer, and the plurality of microcavities includes a liquid crystal material.

The substrate may include a display area and a peripheral area, and the at least one partition wall may be disposed in the peripheral area.

The liquid crystal display may further include a light blocking layer disposed on the substrate, in which the light blocking layer may be disposed in the peripheral area, and the at least one partition wall may be disposed on the light blocking layer.

The at least one partition wall may have a linear shape along the peripheral area.

A plurality of partition walls may be disposed along an edge of the substrate.

The plurality of partition walls may be adjacent to each other in a direction facing the peripheral area in the display area.

The at least one partition wall may be disposed at a same layer as the roof layer.

The at least one partition wall may include a same material as the roof layer.

The liquid crystal display may further include an organic layer disposed between the thin film transistor and the pixel electrode, in which the at least one partition wall may include a same material as the organic layer.

The liquid crystal display may further include a common electrode and a lower insulating layer disposed between the microcavity and the roof layer, in which the lower insulating layer may be disposed on the common electrode.

The liquid crystal display may further include a capping layer disposed on the roof layer, in which a liquid crystal injection hole formation region may be disposed between adjacent microcavities of the plurality of microcavities, and the capping layer may cover the liquid crystal injection hole formation region and the partition wall.

The liquid crystal display may further include an upper insulating layer disposed between the roof layer and the capping layer, in which the upper insulating layer may be extended from the display area to the peripheral area to cover the at least one partition wall.

The liquid crystal injection hole formation region may extend in a parallel direction with the gate line connected to the thin film transistor.

The thin film transistor may be connected to the data line, and a partition wall formation part may be formed between the microcavities in the extending direction of the data line.

Another embodiment provides a method of manufacturing a liquid crystal display, including: forming a thin film transistor on a substrate; forming a pixel electrode to be connected to the thin film transistor; forming a sacrificial layer on the pixel electrode; forming a roof layer on the sacrificial layer; forming at least one partition wall along an edge of the substrate; forming a plurality of microcavities with a liquid crystal injection hole by removing the sacrificial layer; injecting an alignment material in the microcavities; and injecting a liquid crystal material in the plurality of microcavities.

The substrate may include a display area and a peripheral area, and the at least one partition wall may be disposed in the peripheral area.

A liquid crystal injection hole formation region may be disposed between adjacent microcavities of the plurality of microcavities, and when the alignment material is printed on the liquid crystal injection hole formation region, the alignment material may be printed on the peripheral area.

The at least one partition wall may include a same material as the roof layer.

The method of manufacturing a liquid crystal display may further include forming an organic layer disposed between the thin film transistor and the pixel electrode, and the at least one partition wall may include a same material as the organic layer.

When the alignment material is printed on the peripheral area, the partition wall may prevent the alignment material from covering the pad portion disposed in the peripheral area.

According to embodiments of the present invention, since a partition wall having a dam structure is formed at an outer portion, it is possible to secure stability of a module by preventing an over-supplied alignment material from affecting a pad portion even though the alignment material is over-supplied and block light leakage due to non-uniform drying.

### BRIEF DESCRIPTION OF THE DRAWINGS

FIG. 1 is a plan view illustrating a liquid crystal display according to an embodiment.

FIG. 2 is a plan view illustrating some of a plurality of pixels illustrated in FIG. 1.

FIG. 3 is a cross-sectional view of FIG. 2 taken along line

FIG. 4 is a cross-sectional view of FIG. 2 taken along line IV-IV.

FIG. 5 is a cross-sectional view of FIG. 1 taken along line V-V.

FIG. 6 is a cross-sectional view illustrating a liquid crystal display according to an embodiment.

FIG. 7 is a cross-sectional view illustrating a liquid crystal display according to an embodiment.

FIGS. 8 to 20 are cross-sectional views illustrating a method of manufacturing a liquid crystal display according to an embodiment.

### DETAILED DESCRIPTION OF CERTAIN INVENTIVE EMBODIMENTS

The present invention will be described more fully hereinafter with reference to the accompanying drawings, in which certain embodiments of the invention are shown. As those skilled in the art would realize, the described embodiments may be modified in various ways, without departing from the spirit or scope of the present invention. On the contrary, embodiments introduced herein are provided to make disclosed contents thorough and complete and sufficiently transfer the spirit of the present invention to those skilled in the art.

In the drawings, the thickness of layers, films, panels, regions, etc., may be exaggerated for clarity. It will be understood that when a layer is referred to as being “on” another layer or substrate, it can be directly on the other layer or substrate, or intervening them may also be present. Like reference numerals generally designate like elements throughout the specification.

The conventional method of manufacturing a liquid crystal display device includes drying after injecting an aligning agent before injecting the liquid crystal, in order to arrange and align the liquid crystal molecules. Dryness varies according to a position of a display panel and particularly, the drying non-uniformly occurs at an edge of the panel. Accordingly, light leakage may be caused. In order to solve the problem, the aligning agent may be over-supplied, but the over-supplied aligning agent has an effect on a pad portion to deteriorate stability.

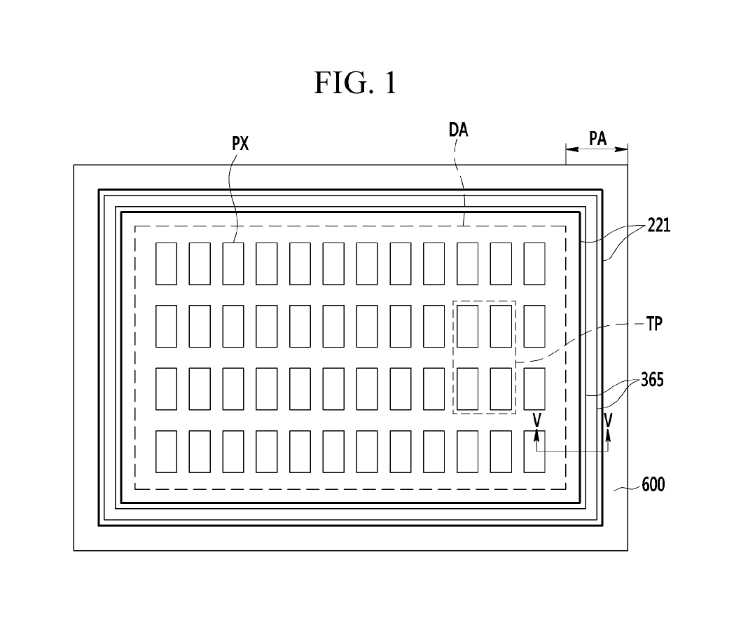

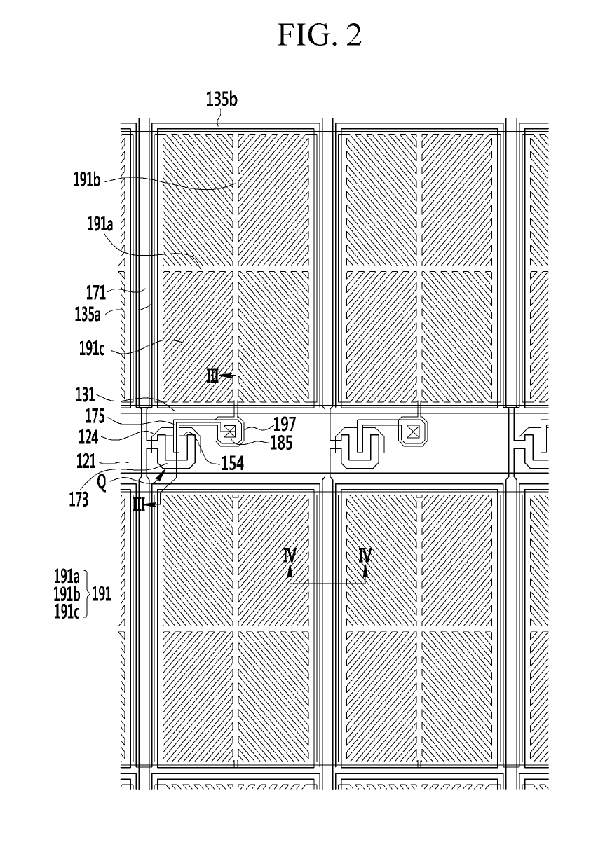

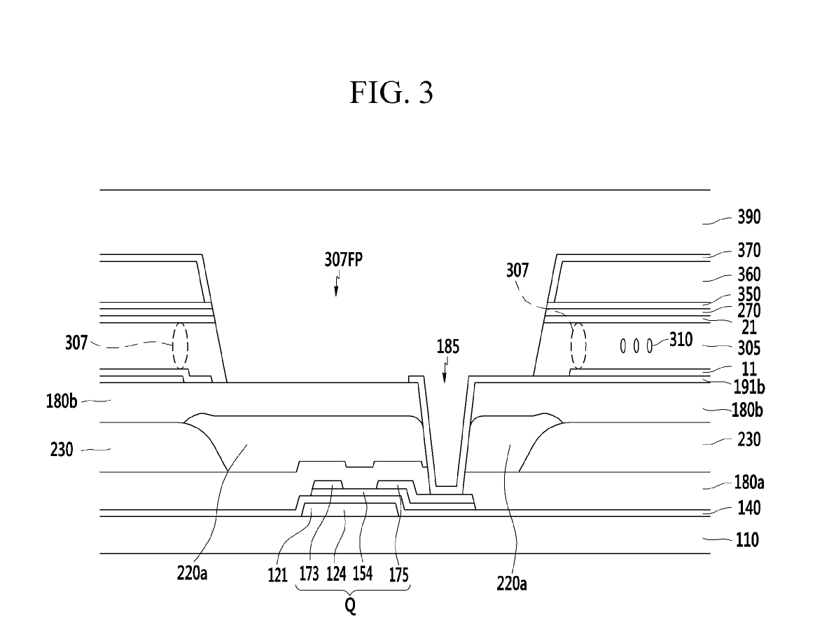

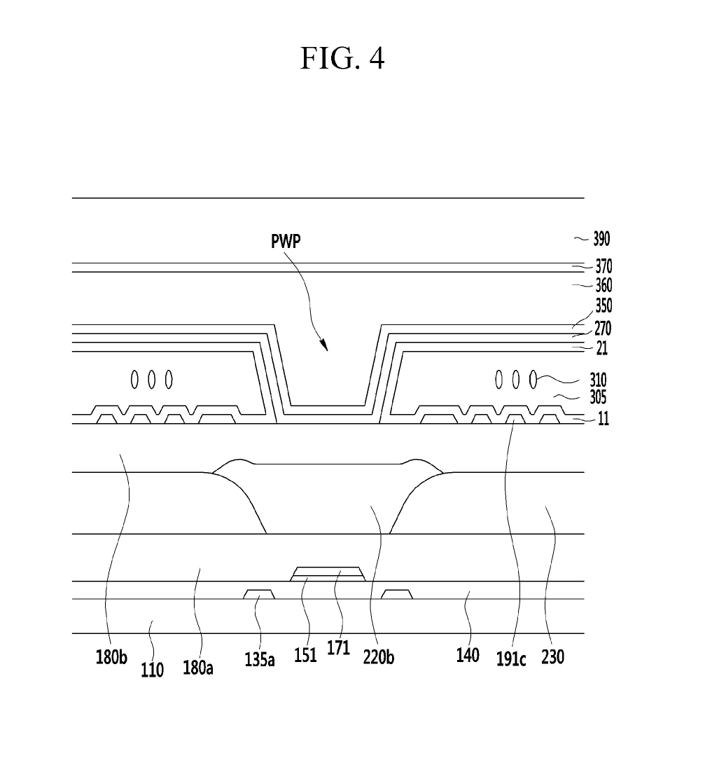

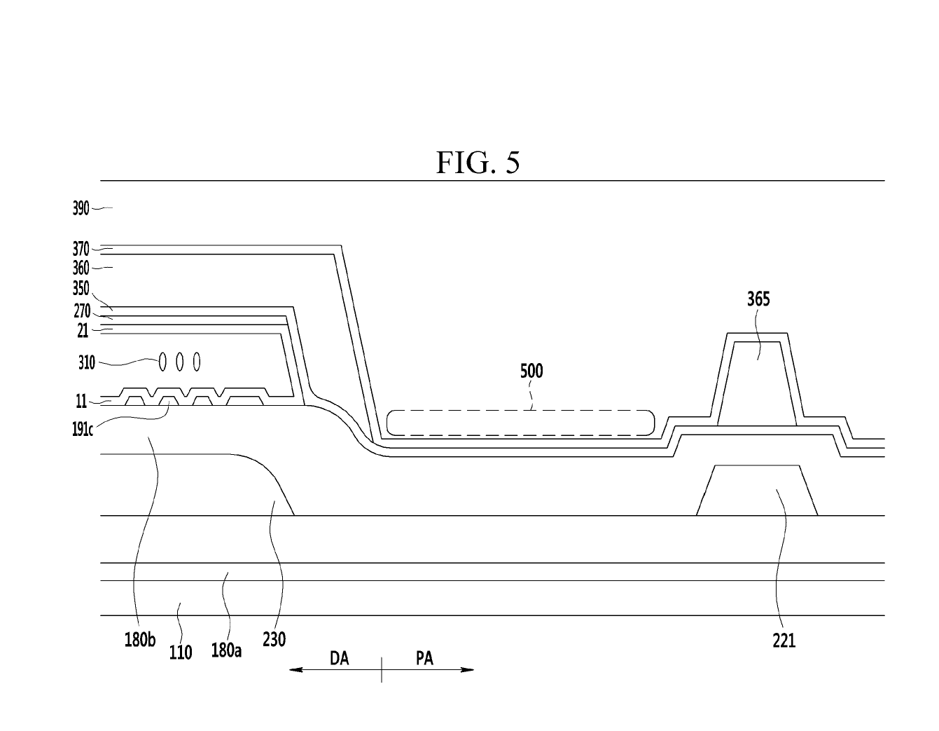

FIG. 1 is a plan view illustrating a liquid crystal display according to an embodiment. FIG. 2 is a plan view illustrating some of a plurality of pixels illustrated in FIG. 1. FIG. 3 is a cross-sectional view of FIG. 2 taken along line FIG. 4 is a cross-sectional view of FIG. 2 taken along line IV-IV. FIG. 5 is a cross-sectional view of FIG. 1 taken along line V-V.

First, referring to FIG. 1, the liquid crystal display includes a display area DA and a peripheral area PA, and as illustrated in FIG. 1, the display area DA represents an inside of a quadrangle marked by a dotted line, and the peripheral area PA represents an outside of the quadrangle marked by a dotted line. The display area DA is an area that outputs an image, and a pad portion 600 or a driver may be disposed in the peripheral area PA. A pad at the pad portion 600 of FIG. 1 may be disposed at any one side of the peripheral area PA or two sides which do not face each other.

In the display area DA, a plurality of pixels PX is disposed, and in the peripheral area PA, a light blocking layer 221 covering a portion where light leakage may occur is disposed. The light blocking layer 221 may be formed outside the display area DA to surround the display area DA. The light blocking layer 221 may be formed at a same layer as a light blocking member 220 disposed in the display area DA with the same material. The light blocking layer 221 may serve to block external light from being reflected and recognized. A partition wall 365 may be disposed at a portion overlapping with the light blocking layer 221.

In some embodiments, the partition wall 365 may be disposed along one side of the peripheral area PA, two sides of the peripheral area PA, or three sides of the peripheral area PA.

Referring to FIGS. 2 to 4, pixels PX disposed in the display area DA will be described in detail. FIG. 2 illustrates a 2×2 pixel portion TP among the plurality of pixels illustrated in FIG. 1.

Referring to FIGS. 2 to 4, a gate line 121 and a storage electrode line 131 are formed on a substrate 110 made of transparent glass, plastic, or the like. The gate line 121 includes a gate electrode 124. The storage electrode line 131 mainly extends in a horizontal direction to transfer a predetermined voltage such as a common voltage Vcom. The storage electrode line 131 includes a pair of vertical portions 135a extending upward to be substantially vertical to the gate line 121, and a horizontal portion 135b connecting ends of the pair of vertical portions 135a. The storage electrodes 135a and 135b have a structure surrounding a pixel electrode 191.

A gate insulating layer 140 is formed on the gate line 121 and the storage electrode line 131. On the gate insulating layer 140, a semiconductor layer 151 disposed below a data line 171, and a semiconductor layer 154 disposed below source/drain electrodes and at a channel portion of a thin film transistor Q are formed.

A plurality of ohmic contacts may be formed on the respective semiconductor layers 151 and 154 and between the data line 171 and the source/drain electrodes, and is omitted in the drawing.

A data conductor 171, 173, and 175 including a source electrode 173, a data line 171 connected to the source electrode 173, and a drain electrode 175 is disposed on the respective semiconductors 151 and 154 and the gate insulating layer 140.

The gate electrode 124, the source electrode 173, and the drain electrode 175 form a thin film transistor Q together with the semiconductor 154, and a channel of the thin film transistor Q is formed in the semiconductor 154 between the source electrode 173 and the drain electrode 175.

A first interlayer insulating layer 180a is formed on the data conductor 171, 173, and 175, and an exposed portion of the semiconductor 154. The first interlayer insulating layer 180a may include an inorganic insulator such as, for example, silicon nitride (SiNx) and silicon oxide (SiOx) or an organic insulator.

A color filter 230 and a light blocking member 220 are formed on the first interlayer insulating layer 180a.

The light blocking member 220 is formed in a lattice structure having an opening corresponding to an area displaying the image, and made of a material which does not transmit light. The color filter 230 is formed in the opening of the light blocking member 220. The light blocking member 220 includes a horizontal light blocking member 220a formed in a parallel direction with the gate line 121, and a vertical light blocking member 220b formed in a parallel direction to the data line 171.

The color filter 230 may display one of the primary colors such as, for example, three primary colors of red, green and blue. However, the color filter 230 is not limited to the three primary colors of red, green and blue, but may display one of cyan, magenta, yellow, and white-based colors. The color filter 230 may be made of a material displaying different colors for every adjacent pixel.

A second interlayer insulating layer 180b covering the color filter 230 and the light blocking member 220 is formed on the color filter 230 and the light blocking member 220. The second interlayer insulating layer 180b may include an inorganic insulator such as, for example, silicon nitride (SiNx) and silicon oxide (SiOx) or an organic insulator. Unlike those illustrated in the cross-sectional view of FIG. 2, when a step is generated due to a thickness difference between the color filter 230 and the light blocking member 220, the second interlayer insulating layer 180b includes the organic insulator to reduce or remove the step.

A contact hole 185 exposing the drain electrode 175 is formed in the color filter 230, the light blocking member 220, and the interlayer insulating layers 180a and 180b.

The pixel electrode 191 is formed on the second interlayer insulating layer 180b. The pixel electrode 191 may be made of a transparent conductive material such as, for example, ITO or IZO.

An overall shape of the pixel electrode 191 is a quadrangle, and includes a cross stem configured by a horizontal stem 191a and a vertical stem 191b crossing the horizontal stem 191a. Further, the pixel electrode 191 is divided into four subregions by the horizontal stem 191a and the vertical stem 191b, and each subregion includes a plurality of minute branches 191c. In one embodiment, the pixel electrode 191 may further include an outer stem surrounding an outside.

The minute branch 191c of the pixel electrode 191 forms an angle of approximately 40° to 45° with the gate line 121 or the horizontal stem 191a. Further, the minute branches of two adjacent subregions may be perpendicular to each other. Further, a width of the minute branch is gradually increased, or a distance between the minute branches 191c may vary.

The pixel electrode 191 includes an extension 197 which is connected to a lower end of the vertical stem 191b and has a larger area than the vertical stem 191b, and is physically and electrically connected with the drain electrode 175 through the contact hole 185 at the extension 197 to receive a data voltage from the drain electrode 175.

The thin film transistor Q and the pixel electrode 191 described above are just described as an example, and a structure of the thin film transistor and a design of the pixel electrode may be modified in order to improve side visibility.

A lower alignment layer 11 is formed on the pixel electrode 191, and may be a vertical alignment layer. The lower alignment layer 11, as a liquid crystal alignment layer such as polyamic acid, polysiloxane, polyimide, or the like, may include at least one of generally used materials.

An upper alignment layer 21 is disposed at a portion facing the lower alignment layer 11, and a microcavity 305 is formed between the lower alignment layer 11 and the upper alignment layer 21. A liquid crystal material including liquid crystal molecules 310 is injected into the microcavity 305, and the microcavity 305 has a liquid crystal injection hole 307. The microcavity 305 may be formed in a column direction, that is, a vertical direction of the pixel electrode 191. In one embodiment, an alignment material forming the alignment layers 11 and 21 and a liquid crystal material including the liquid crystal molecules 310 may be injected into the microcavity 305 by using capillary force.

The microcavity 305 is divided in a vertical direction by a plurality of liquid crystal injection hole formation regions 307FP disposed at the portion overlapping with the gate line 121, and further, a plurality of microcavities is formed in a direction in which the gate line 121 extends. The plurality of microcavities 305 may correspond to one or two or more pixel areas, and the pixel area may correspond to the area displaying a screen.

A common electrode 270 and a lower insulating layer 350 are disposed on the upper alignment layer 21. The common electrode 270 receives a common voltage and generates an electric field together with the pixel electrode 191 to which the data voltage is applied to determine tilt directions of the liquid crystal molecules 310 disposed in the microcavity 305 between the two electrodes. The common electrode 270 forms a capacitor together with the pixel electrode 191 to maintain the applied voltage even after the thin film transistor is turned off. The lower insulating layer 350 may be formed of, for example, silicon nitride (SiNx) or silicon oxide (SiO2).

In one embodiment, the common electrode 270 is formed on the microcavity 305, but in another embodiment, the common electrode 270 is formed below the microcavity 305 and thus the liquid crystal may be driven according to an in-plane switching mode.

A roof layer 360 is disposed on the lower insulating layer 350. The roof layer 360 serves to support the microcavity 305 which is a space between the pixel electrode 191 and the common electrode 270. The roof layer 360 may include a photoresist, or other organic materials.

The upper insulating layer 370 is disposed on the roof layer 360. The upper insulating layer 370 may contact an upper surface of the roof layer 360. The upper insulating layer 370 may be formed of, for example, silicon nitride (SiNx) or silicon oxide (SiO2).

In one embodiment, a capping layer 390 fills the liquid crystal injection hole formation region 307FP and covers the liquid crystal injection hole 307 of the microcavity 305 exposed by the liquid crystal injection hole formation region 307FP. The capping layer 390 includes an organic material or an inorganic material.

In the embodiment illustrated in FIG. 4, a partition wall formation part PWP is disposed between the microcavities 305 adjacent to each other in a horizontal direction. The partition wall formation part PWP may be formed in an extending direction of the data line 171 and may be covered by the roof layer 360. In one embodiment, the lower insulating layer 350, the common electrode 270, the upper insulating layer 370, and the roof layer 360 are filled in the partition wall formation part PWP, and the structure may partition or define the microcavity 305 by forming the partition wall. In one embodiment, since a partition wall structure such as the partition wall formation part PWP exists between the microcavities 305, a stress generated even though the insulation substrate 110 is bent is small, and a changed degree of a cell gap may be much reduced.

Hereinafter, referring to FIGS. 1 and 5, a structural feature of the peripheral area PA according to an embodiment will be described.

Referring to FIGS. 1 and 5, an edge portion 500 is formed in the peripheral area PA adjacent to the pixel PX disposed at an edge of the display area DA. The edge portion 500 corresponds to a space between an outermost pixel PX and the light blocking layer 221 of the peripheral area PA.

In one embodiment, a partition wall 365 is disposed on the light blocking layer 221 disposed in peripheral area PA. The partition wall 365 may be formed in a linear shape along one side of the peripheral area PA. The partition wall 365 may be disposed at a same layer as the roof layer 360 and may be formed with the same material.

When an aligning agent is injected and then dried, a dry characteristic varies according to a position of the liquid crystal display panel, and particularly, drying non-uniformity occurs at the edge of the display area DA. Accordingly, light leakage may be caused. In order to solve this problem, the aligning agent may be over-supplied. In this case, the aligning agent may be supplied to the edge portion 500 illustrated in FIG. 5. The aligning agent over-supplied to the edge portion 500 affects the pad portion 600, thereby deteriorating stability of a module.

However, in one embodiment, since the partition wall 365 is formed between the pad portion 600 and the edge portion 500, the stability of the pad portion 600 may be secured in spite of the over-supplied aligning agent. Further, a remaining solid which is evaporated in the edge portion 500 is uniformly distributed to prevent light leakage which may be recognized at the edge portion 500.

The second interlayer insulating layer 180b and the lower insulating layer 350 are disposed between the light blocking layer 221 of the peripheral area PA and the partition wall 365. The upper insulating layer 370 in the display area DA on the partition wall 365 is extended up to the peripheral area PA to cover the partition wall 365. The capping layer 390 may cover the display area DA and the peripheral area PA.

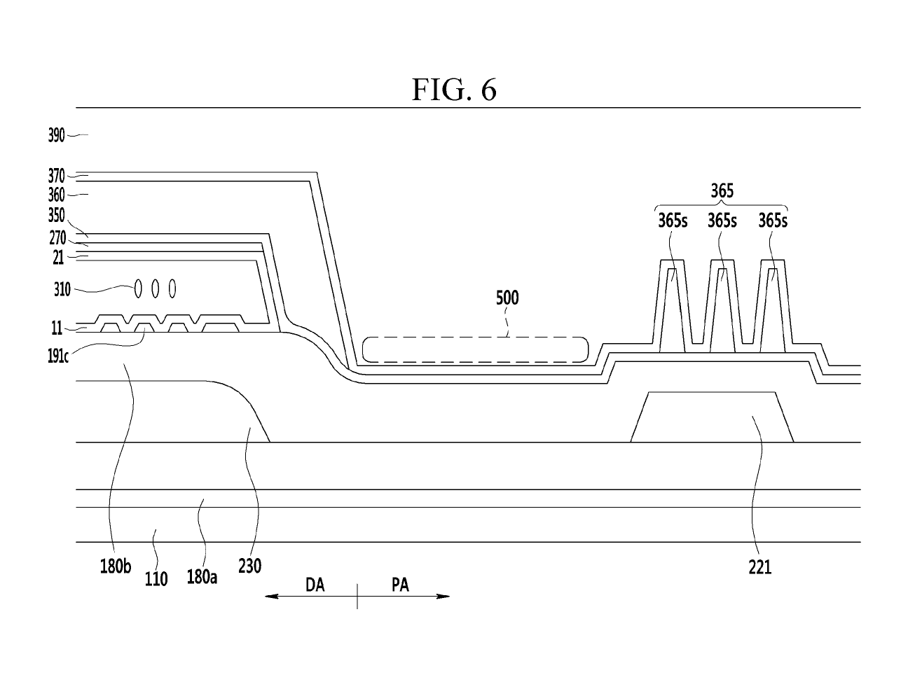

FIG. 6 is a cross-sectional view illustrating a liquid crystal display according to an embodiment.

The embodiment in FIG. 6 is almost the same as the embodiment described with reference to FIG. 5, but a partition wall structure is different.

Referring to FIG. 6, the partition wall 365 includes a plurality of small partition walls 365s. The plurality of small partition walls 365s is formed on the light blocking layer 221 in the peripheral area PA.

The description of FIG. 5 except for the difference described above may be applied to the embodiment of FIG. 6.

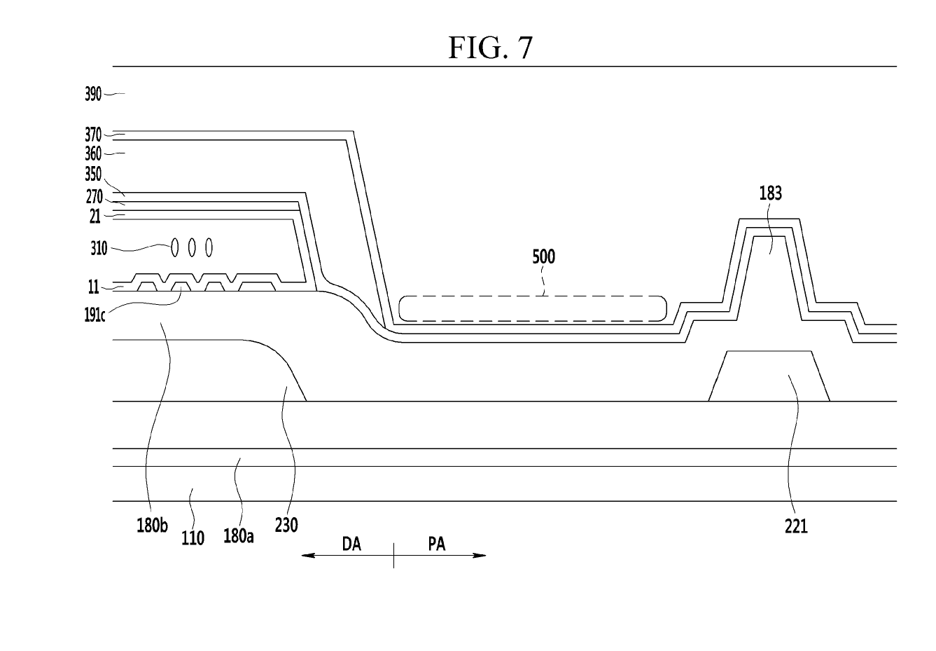

FIG. 7 is a cross-sectional view illustrating a liquid crystal display according to an embodiment.

The embodiment in FIG. 6 is almost the same as the embodiment described with reference to FIG. 5, but a partition wall structure is different.

Referring to FIG. 7, a partition wall 183 is a portion formed when the second interlayer insulating layer 180b covering the light blocking layer 221 protrudes upward. The partition wall 183 may be formed by using a slit mask, a halftone mask, or the like. On the partition wall 183, the lower insulating layer 350 and the upper insulating layer 370 in the display area DA are extended up to the peripheral area PA to cover the partition wall 183.

The description of FIG. 5 except for the difference described above may be applied to embodiment of FIG. 7.

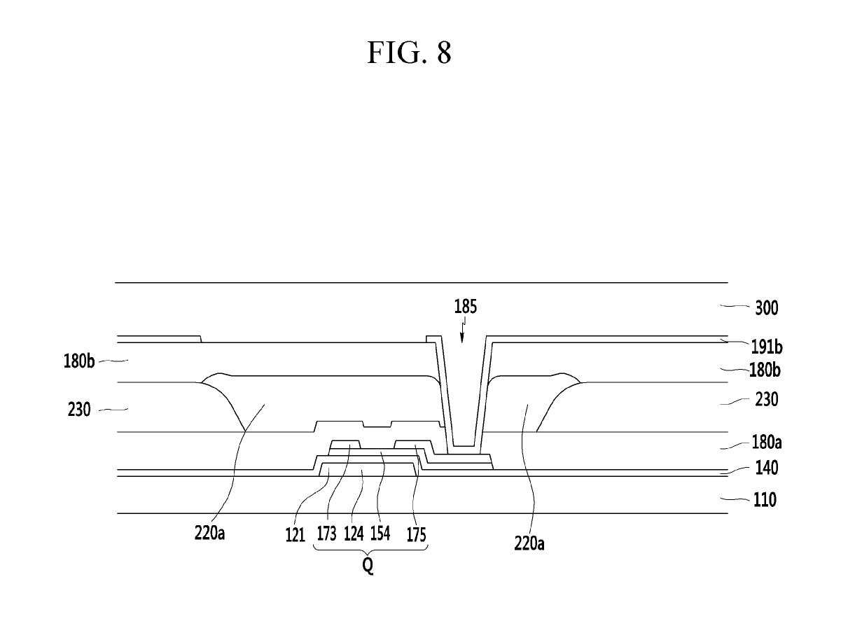

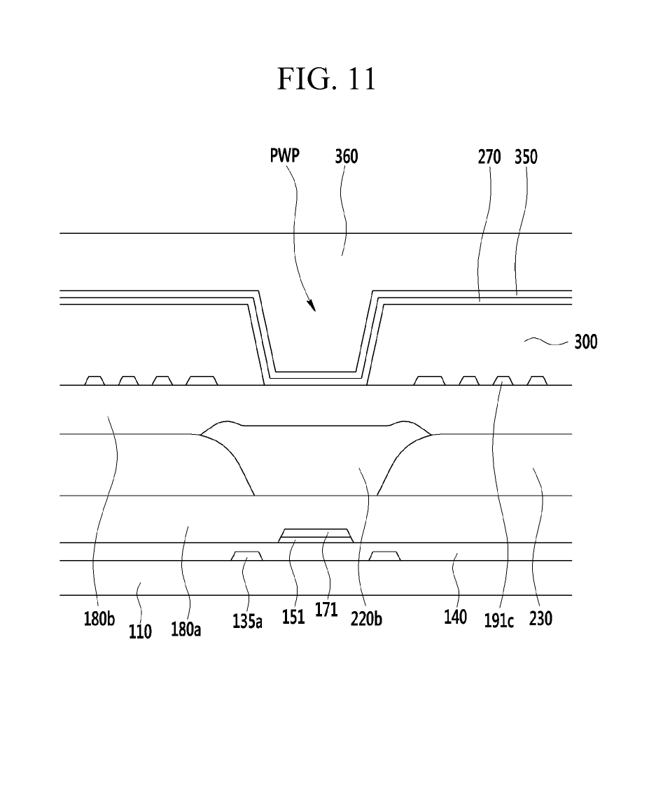

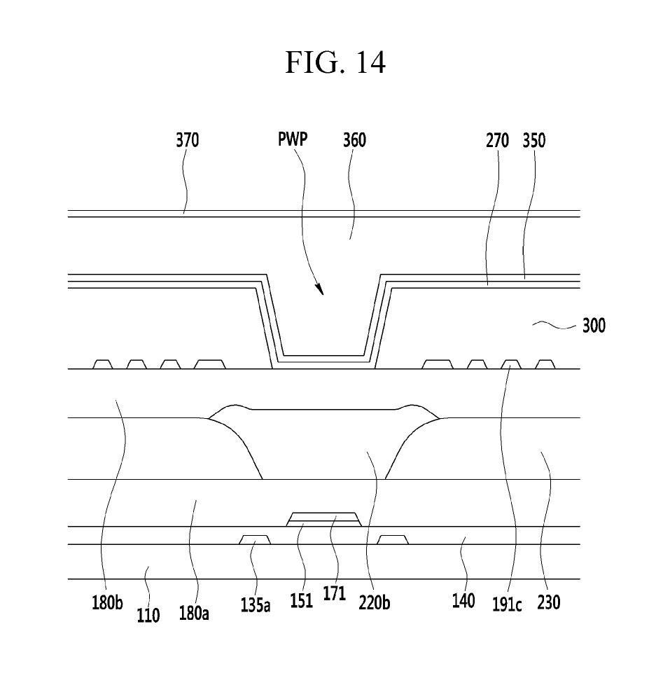

Hereinafter, an embodiment for a method of manufacturing the liquid crystal display described above will be described with reference to FIGS. 8 to 20. The embodiment described may be modified in various forms in other embodiments.

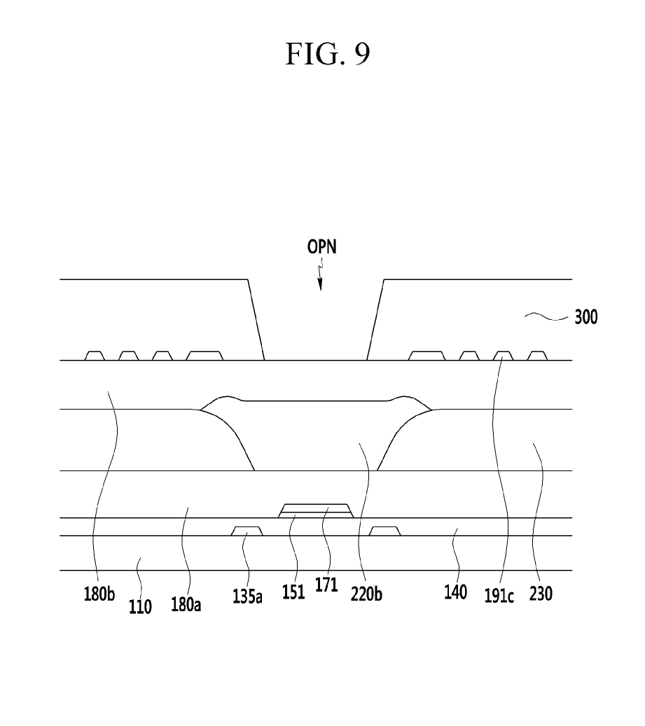

FIGS. 8 to 20 are cross-sectional views illustrating a method of manufacturing a liquid crystal display according to an embodiment. FIGS. 8, 10, 13, 16, 17, and 19 illustrate cross-sectional views of FIG. 2 taken along line in sequence. FIGS. 9, 11, 14, 18, and 20 are cross-sectional views of FIG. 2 taken along line IV-IV.

Referring to FIGS. 2, 8, and 9, the gate line 121 extending in a horizontal direction in order to form a switching element on the substrate 110, the gate insulating layer 140 on the gate line 121, the semiconductor layers 151 and 154 on the gate insulating layer 140, and the source electrode 173 and the drain electrode 175 are formed. In this case, the data line 171 connected with the source electrode 173 may be formed to cross the gate line 121 and extend in a vertical direction.

On the data conductor 171, 173, and 175 including the source electrode 173, the drain electrode 175, and the data line 171 and the exposed portion of the semiconductor layer 154, the first interlayer insulating layer 180a is formed.

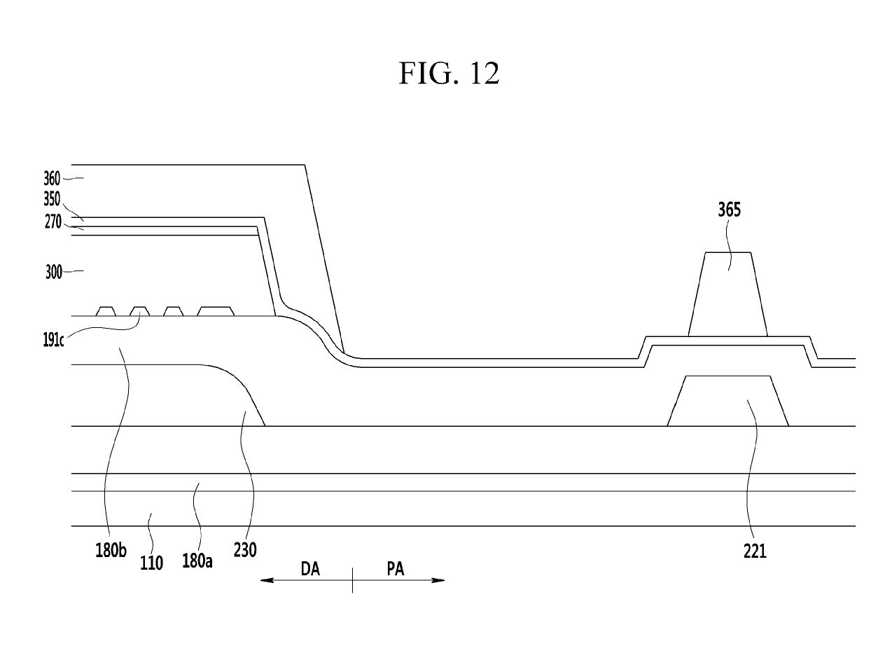

On the first interlayer insulating layer 180a, the color filter 230 is formed at a position corresponding to the pixel area, and the light blocking member 220 is formed between the color filters 230. When the light blocking member 220 is formed, as illustrated in FIG. 12, the light blocking layer 221 disposed on the peripheral area PA may be simultaneously formed.

On the color filter 230 and the light blocking member 220, the second interlayer insulating layer 180b covering the color filter 230 and the light blocking member 220 is formed, and the second interlayer insulating layer 180b is formed to have the contact hole 185 electrically and physically connecting the pixel electrode 191 and the drain electrode 175.

Thereafter, the pixel electrode 191 is formed on the second interlayer insulating layer 180b, and a sacrificial layer 300 is formed on the pixel electrode 191. As illustrated in FIG. 5, an open portion OPN is formed in a parallel direction with the data line 171 in the sacrificial layer 300. In a subsequent process, the common electrode 270, the lower insulating layer 350, the roof layer 360, and the upper insulating layer 370 are filled in the open portion OPN to form the partition wall formation part PWP.

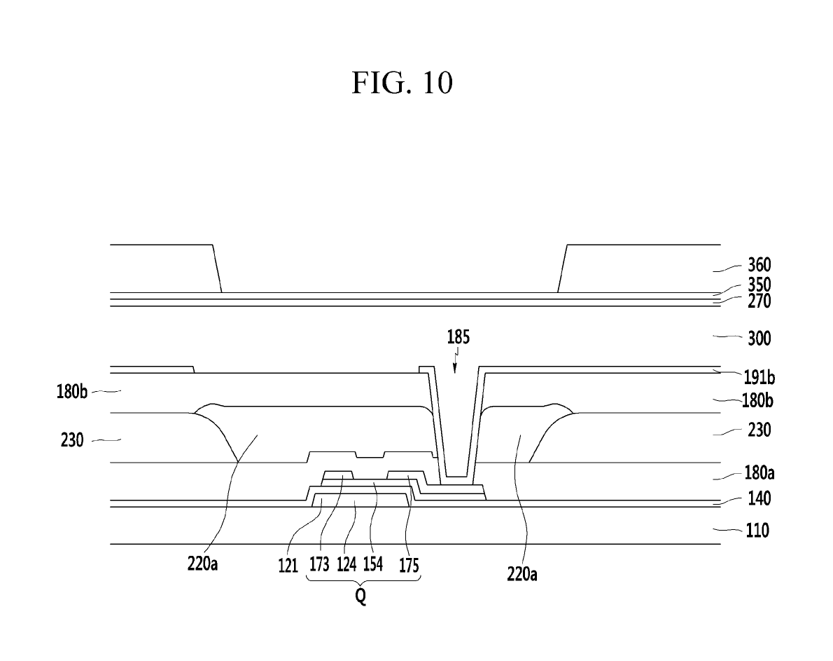

Referring to FIGS. 10 to 12, the common electrode 270, the lower insulating layer 350, and the roof layer 360 are sequentially formed on the sacrificial layer 300. The roof layer 360 may be removed in a region corresponding to the light blocking member 220 disposed between the adjacent pixel areas in the vertical direction through exposing and developing processes. The roof layer 360 exposes the lower insulating layer 350 outside in the region corresponding to the light blocking member 220. In this case, the common electrode 270, the lower insulating layer 350, and the roof layer 360 fill the open portion OPN of the vertical light blocking member 220b to form the partition wall formation part PWP. When the roof layer 360 is formed, the partition wall 365 may be formed in the peripheral area PA by using a slit mask, a halftone mask, or the like. Accordingly, the partition wall 365 may be disposed at a same layer as the roof layer 360 with the same material. The partition wall 365 may be separated from the roof layer 360.

Unlike this, the partition wall 365 is not formed as the roof layer 360, and as illustrated in FIG. 7, the partition wall 365 may be formed together with the second interlayer insulating layer 180b. In this case, the second interlayer insulating layer 180b may be formed with an organic material through a photolithography process. The second interlayer insulating layer 180b is formed by using the slit mask or the halftone mask to have a part of the second interlayer insulating layer 180b protruding upward. The part of the second interlayer insulating layer 180b protruding upward may form the partition wall 183 as illustrated in FIG. 7.

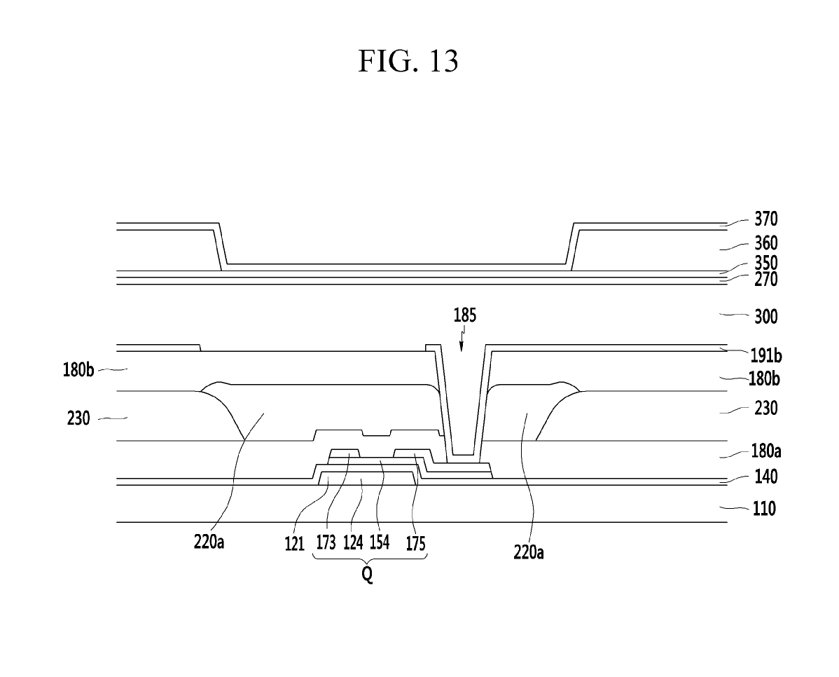

Referring to FIGS. 13 to 15, the upper insulating layer 370 is formed to cover the roof layer 360 and the exposed lower insulating layer 350. The upper insulating layer 370 is extended up to the peripheral area PA to cover the partition wall 365. Here, the edge portion 500 may be formed between the partition wall 365 and the roof layer 360 of the display area DA. The edge portion 500 elongates in the extending direction of the partition wall 365.

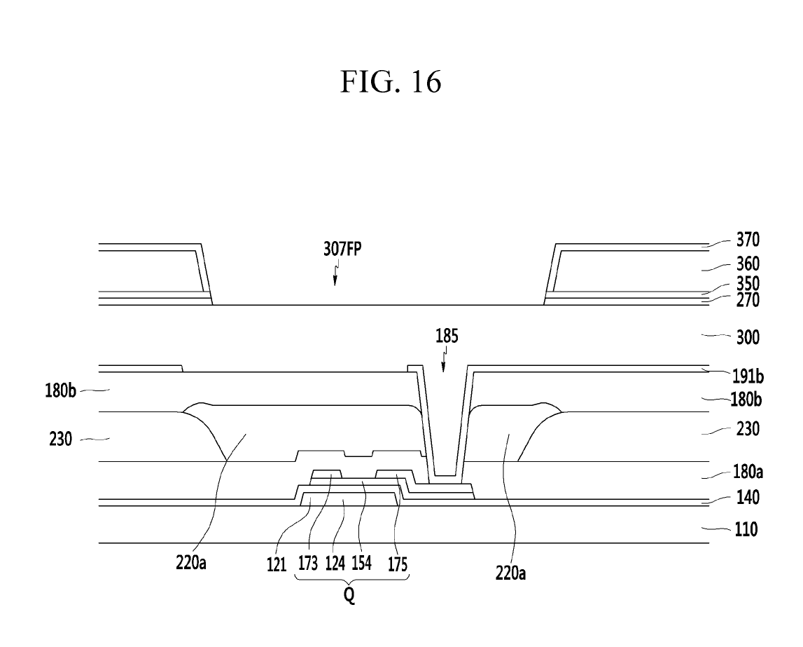

Referring to FIG. 16, the upper insulating layer 370, the lower insulating layer 350, and the common electrode 270 are partially removed by dry-etching the upper insulating layer 370, the lower insulating layer 350, and the common electrode 270 to form the liquid crystal injection hole formation region 307FP. In this case, the upper insulating layer 370 may have a structure covering the side of the roof layer 360, but is not limited thereto, and the upper insulating layer 370 covering the side of the roof layer 360 is removed to expose the side of the roof layer 360 outside.

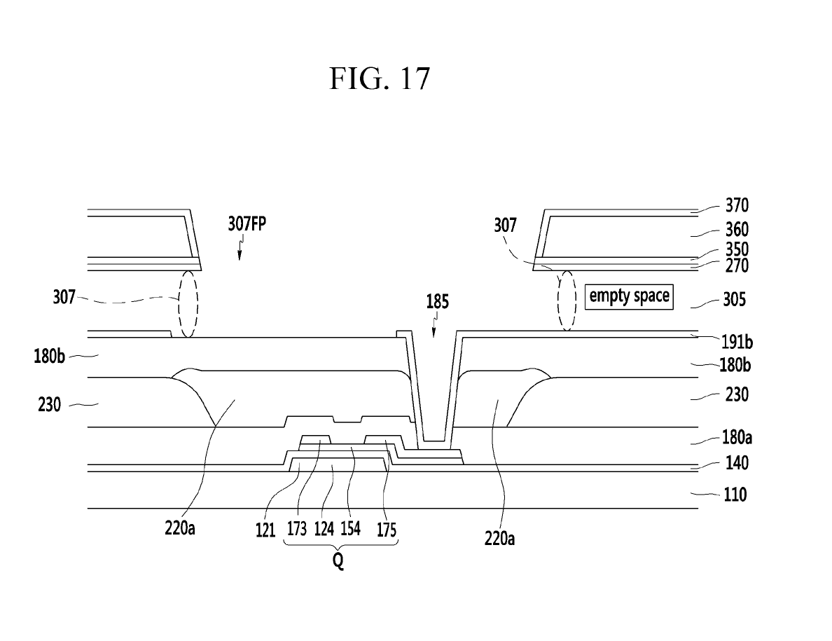

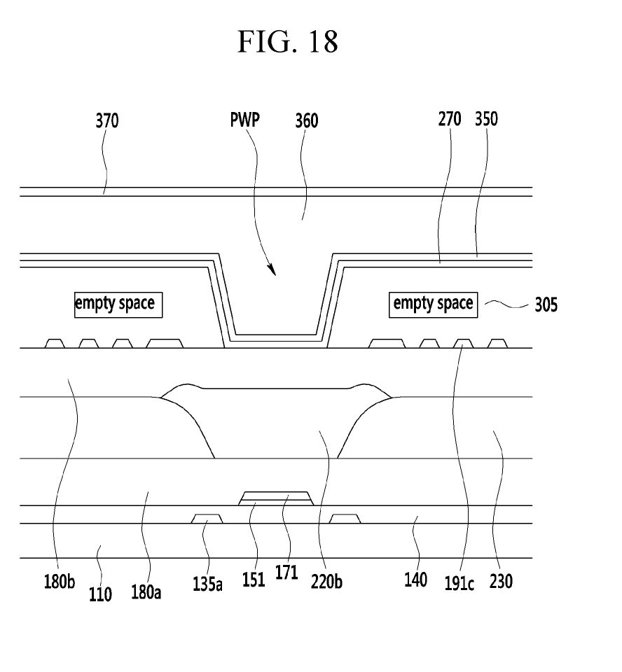

Referring to FIGS. 17 and 18, the sacrificial layer 300 is removed by an oxygen (O₂) ashing process, a wet-etching method, or the like through the liquid crystal injection hole formation region 307FP. In this case, the microcavity 305 having the liquid crystal injection hole 307 is formed. The microcavity 305 is an empty space formed when the sacrificial layer is removed.

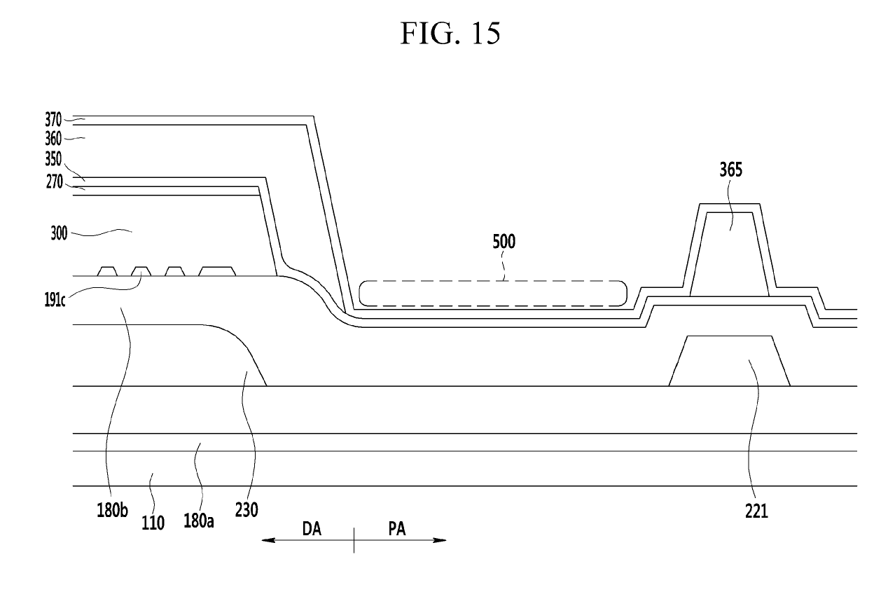

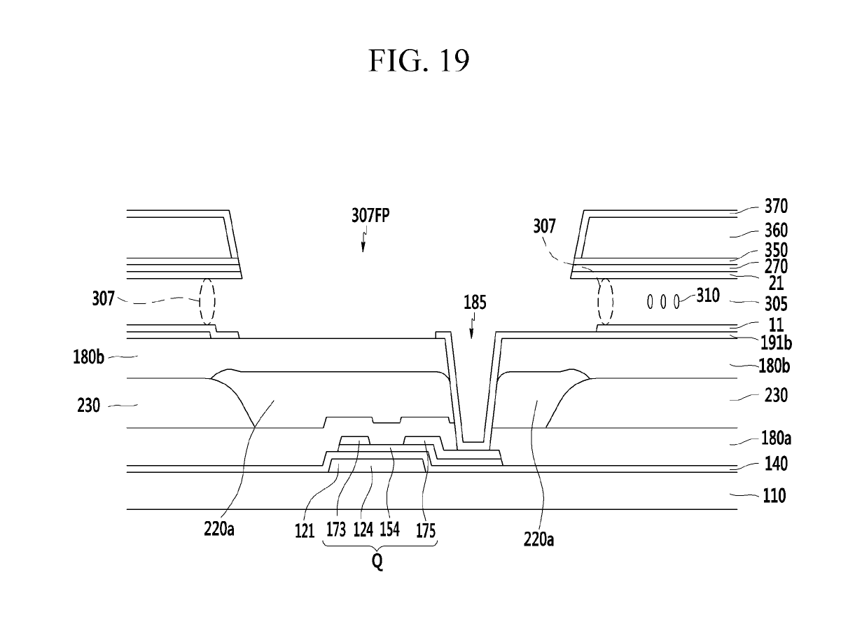

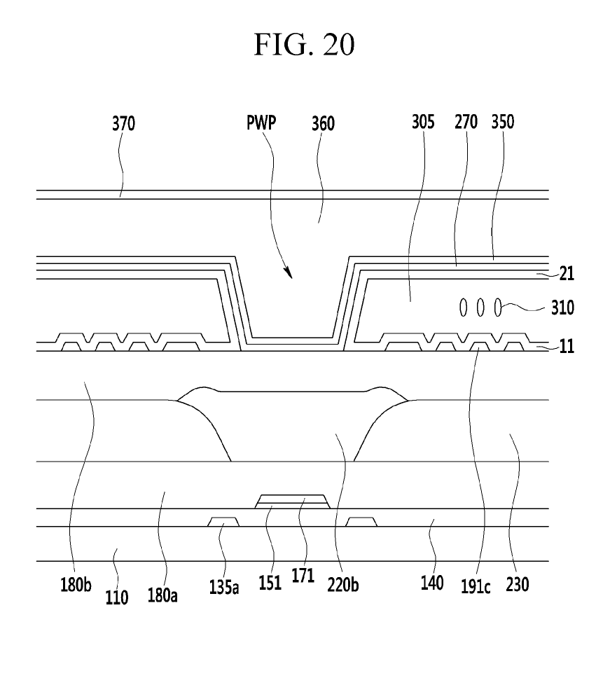

Referring to FIGS. 19 and 20, the alignment layers 11 and 21 are formed on the pixel electrode 191 and the common electrode 270 by injecting the aligning material through the liquid crystal injection hole 307. A bake process is performed after injecting the aligning material including a solid and a solvent through the liquid crystal injection hole 307. The aligning agent may be sufficiently over-supplied even at the edge of the display area DA so that drying of the aligning agent is uniformly performed through the bake process. For example, when a capacity completely filling the plurality of microcavities 305 is 100%, a capacity of the over-supplied aligning agent may be about 120% to about 300%. The over-supplied aligning agent may be filled up to the edge portion 500 of a non-display area PA. As illustrated in FIGS. 1 and 15, the aligning agent filled in the edge portion 500 is blocked by the partition wall 365 to be prevented from flowing into the pad portion 600. Further, since the bake process is performed in a state where the aligning agent is sufficiently filled even in the edge portion 500, the remaining solid after drying may be uniformly distributed.

Next, the liquid crystal material including the liquid crystal molecules 310 is injected into the microcavity 305 through the liquid crystal injection hole 307 by using an inkjet method and the like.

Thereafter, the capping layer 390 is formed on the upper insulating layer 370 to cover the liquid crystal injection hole 307 and the liquid crystal injection hole formation region 307FP to form the liquid crystal display like FIG. 3. In this case, the capping layer 390 may be formed to cover the partition wall 365 of the peripheral area PA as illustrated in FIG. 5.

While this invention has been described in connection with certain embodiments, it is to be understood that the invention is not limited to the disclosed embodiments, but, on the contrary, is intended to cover various modifications and equivalent arrangements included within the spirit and scope of the appended claims.

What is claimed is:

1. A liquid crystal display, comprising:
a substrate;
a thin film transistor disposed on the substrate;
a pixel electrode disposed on the thin film transistor;
a roof layer facing the pixel electrode; and
at least one partition wall disposed along an edge of the substrate,
wherein a plurality of microcavities is formed between the pixel electrode and the roof layer, and the plurality of microcavities includes a liquid crystal material.

2. The liquid crystal display of claim 1, wherein:
the substrate includes a display area and a peripheral area, and wherein the at least one partition wall is disposed in the peripheral area.

3. The liquid crystal display of claim 2, further comprising:
a light blocking layer disposed on the substrate,
wherein the light blocking layer is disposed in the peripheral area, and wherein the at least one partition wall is disposed on the light blocking layer.

4. The liquid crystal display of claim 3, wherein:
the at least one partition wall has a linear shape along the peripheral area.

5. The liquid crystal display of claim 4, wherein:
a plurality of partition walls are disposed along the edge of the substrate.

6. The liquid crystal display of claim 5, wherein:
the plurality of partition walls are adjacent to each other in a direction facing the peripheral area in the display area.

7. The liquid crystal display of claim 4, wherein:
the at least one partition wall is disposed at a same layer as the roof layer.

8. The liquid crystal display of claim 7, wherein:
the at least one partition wall comprises a same material as the roof layer.

9. The liquid crystal display of claim 4, further comprising:
an organic layer disposed between the thin film transistor and the pixel electrode, wherein the at least one partition wall comprises a same material as the organic layer.

10. The liquid crystal display of claim 2, further comprising:
a common electrode and a lower insulating layer disposed between the microcavity and the roof layer,
wherein the lower insulating layer is disposed on the common electrode.

11. The liquid crystal display of claim 10, further comprising:
a capping layer disposed on the roof layer, wherein a liquid crystal injection hole formation region is disposed between adjacent microcavities of the plurality of microcavities, and the capping layer covers the liquid crystal injection hole formation region and the partition wall.

12. The liquid crystal display of claim 11, further comprising:
an upper insulating layer disposed between the roof layer and the capping layer, wherein the upper insulating layer is extended from the display area to the peripheral area to cover the at least one partition wall.

13. The liquid crystal display of claim 12, wherein:
the liquid crystal injection hole formation region extends in a parallel direction with the gate line connected to the thin film transistor.

14. The liquid crystal display of claim 13, wherein:
the thin film transistor is connected to the data line, and a partition wall formation part is formed between the microcavities in the extending direction of the data line.

15. A method of manufacturing a liquid crystal display, comprising:
forming a thin film transistor on a substrate;
forming a pixel electrode to be connected to the thin film transistor;
forming a sacrificial layer on the pixel electrode;
forming a roof layer on the sacrificial layer;
forming at least one partition wall along an edge of the substrate;
forming a plurality of microcavities with a liquid crystal injection hole by removing the sacrificial layer;
injecting an alignment material in the microcavities; and
injecting a liquid crystal material in the plurality of microcavities.

16. The method of manufacturing a liquid crystal display of claim 15, wherein:
the substrate includes a display area and a peripheral area, and the at least one partition wall is disposed in the peripheral area.

17. The method of manufacturing a liquid crystal display of claim 16, wherein:
a liquid crystal injection hole formation region is disposed between adjacent microcavities of the plurality of microcavities, and when the alignment material is printed on the liquid crystal injection hole formation region, the alignment material is printed on the peripheral area.

18. The method of manufacturing a liquid crystal display of claim 17, wherein:
the at least one partition wall comprises a same material as the roof layer.

19. The method of manufacturing a liquid crystal display of claim 17, further comprising:
forming an organic layer disposed between the thin film transistor and the pixel electrode, wherein the at least one partition wall comprises a same material as the organic layer.

20. The method of manufacturing a liquid crystal display of claim 17, wherein:
when the alignment material is printed on the peripheral area, the partition wall prevents the alignment material from covering the pad portion disposed in the peripheral area.
